(19) United States
(12) Patent Application Publication
(10) Pub. No.: US 2012/0017935 A1
(43) Pub. Date: Jan. 26, 2012

(54) MAGNETIC TAPE HEAD CLEANING

(75) Inventors: DYLAN J. BODAY, TUCSON, AZ (US); WAYNE A. McKINLEY, TUCSON, AZ (US); LEE C. RANDALL, TUCSON, AZ (US); RICHARD A. WEST, TUCSON, AZ (US)

(73) Assignee: INTERNATIONAL BUSINESS MACHINES CORPORATION, ARMONK, NY (US)

(21) Appl. No.: 12/840,914

(22) Filed: Jul. 21, 2010

(51) Int. Cl. G11B 5/41

(52) U.S. Cl. 134/6; 15/210.1

(57) ABSTRACT

An embodiment of a magnetic tape head cleaner for a magnetic tape head, the head having at least one read/write surface, wherein the magnetic tape head is configured to read and write data with respect to a movable magnetic tape as the tape is moved in a longitudinal direction of the tape and across the read/write surface(s) of the head, employs a closed cellular polyurethane foam pad; and a support member configured to support the pad for movement of the pad across and in contact with the read/write surface(s) of the magnetic tape head. The closed cellular polyurethane foam pad may have a Shore hardness of substantially 55-60.

### FIELD OF THE INVENTION

This invention relates to magnetic tape drives, and more particularly to magnetic tape heads which read and write data with respect to a movable magnetic tape.

### BACKGROUND OF THE INVENTION

Magnetic tape drives function to read and write data with respect to magnetic tape, employing at least one magnetic tape head to read and write data as magnetic tape is moved in a longitudinal direction of the tape and across the read/write surface of the head. The operating performance of the magnetic tape drive can be adversely affected by the build up of tape debris at the tape-head interface. In addition to the common tape debris, polyethylene smears may build up on the head and result in the separation of the tape from the head, adversely affecting the reading and writing of data to and from the tape. Fibrous brushes have been employed with the desire of brushing debris from the tape head.

### SUMMARY OF THE INVENTION

A magnetic tape head cleaners and cleaning methods are provided for a magnetic tape head having at least one read/write surface, wherein the magnetic tape head is configured to read and write data with respect to a movable magnetic tape as the tape is moved in a longitudinal direction of the tape and across the read/write surface(s) of the head.

In one embodiment, a magnetic tape head cleaner comprises:

a closed cellular polyurethane foam pad; and

a support member configured to support the pad for movement of the pad across and in contact with the read/write surface(s) of the magnetic tape head.

In a further embodiment, the closed cellular polyurethane foam pad comprises a Shore hardness of substantially 55-60.

In another embodiment, the closed cellular polyurethane foam pad comprises a density of 1.0 to 0.15 g/cm³, and in a further embodiment, the closed cellular polyurethane foam pad comprises a density of substantially 0.5 to 0.3 g/cm³.

In yet another embodiment, the closed cellular polyurethane foam pad additionally comprises an abrasive particle filler having a concentration of 10 to 0.01 percentage by weight, and in a further embodiment, the closed cellular polyurethane foam pad abrasive particle filler comprises a concentration of substantially 3 to 0.5 percentage by weight.

In a still further embodiment, the abrasive particle filler is one of Alumina and Titanium oxide.

In another embodiment, the closed cellular polyurethane foam pad additionally is impregnated with a carbon based conductive filler having a concentration of 15 to 0.01 percentage by weight, and in a further embodiment, the closed cellular polyurethane foam pad is impregnated with the carbon based conductive filler to a concentration of substantially 5 to 0.5 percentage by weight.

Another embodiment of a magnetic tape head cleaner for a magnetic tape head comprises an interior reinforcing layer; and a closed cellular polyurethane foam pad overlaying the interior reinforcing layer on at least all surfaces that are arranged to contact the read/write surface(s) of the magnetic tape head.

An embodiment of a method for cleaning a magnetic tape head having at least one read/write surface comprises moving a closed cellular polyurethane foam pad comprising a Shore hardness of substantially 55-60 and comprising a density of 1.0 to 0.15 g/cm³ across and in contact with the read/write surface(s) of the magnetic tape head.

For a fuller understanding of the present invention, reference should be made to the following detailed description taken in conjunction with the accompanying drawings.

### BRIEF DESCRIPTION OF THE DRAWINGS

FIG. 1 is a view of a closed cellular polyurethane foam pad tape head cleaner and a magnetic tape head surface;

FIG. 2 is a diagrammatic illustration of the method for cleaning a magnetic tape head with the closed cellular polyurethane foam pad of FIG. 1;

FIG. 3 is a side view of the closed cellular polyurethane foam pad of FIG. 1 mounted in a support member;

FIG. 4 is an alternative view of the support member of FIG. 3;

FIG. 5 is a view of one embodiment of the closed cellular polyurethane foam pad of FIG. 1 held in a holder;

FIG. 6 a view of another embodiment of the closed cellular polyurethane foam pad of FIG. 1 held in a holder; and

FIG. 7 is a partially cut away view of a magnetic tape drive having a closed cellular polyurethane foam pad of FIG. 1 and support member.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

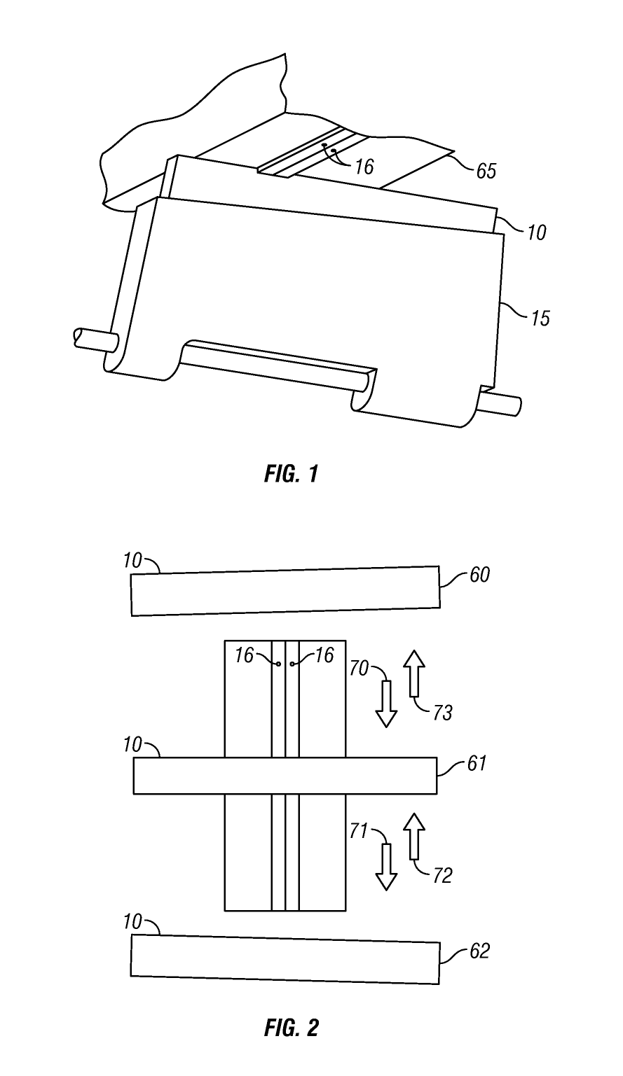

Referring to FIG. 1, a closed cellular polyurethane foam pad 10 is held in a cavity of a holder 15, for example, by being cemented in place, and is employed to clean the read/write surface 16 of a magnetic tape head 65 by moving across and in contact with the read/write surface(s) 16 of the magnetic tape head 65.

Referring additionally to FIG. 2, the closed cellular polyurethane foam pad 10 is initially in a rest position 60 at one side of the magnetic tape head 65. Before a tape is threaded into position at the magnetic tape head 65, the closed cellular polyurethane foam pad 10 is moved in the direction of arrow 70 across and in contact with the read/write surface(s) 16 of the magnetic tape head 65 as illustrated in FIG. 1. In FIG. 2, the position 61 represents the approximate midpoint of the movement of the closed cellular polyurethane foam pad 10, which continues in the direction of arrow 71 until the closed cellular polyurethane foam pad 10 reaches position 62 at the side of the magnetic tape head 65 opposite the rest position. In one embodiment, the closed cellular polyurethane foam pad 10 is moved from rest position 60 to position 62 as a cartridge containing a tape is loaded into position. The pad 10 remains in position 62 as the tape is threaded into position at the magnetic tape head 65 and remains at position 62 as the tape drive moves the tape to read and write data with respect to the tape, and until the tape is unthreaded and returned to the cartridge. The cartridge may then be unloaded from the tape drive. In one embodiment, as the cartridge is unloaded, the movement of the pad is reversed and it is moved in the direction of arrow 72 across and in contact with the read/write surface(s) 16 of the magnetic tape head 65. The position 61 represents the approximate midpoint of the movement of the closed cellular polyurethane foam pad 10, which continues in the direction of arrow 73 until the closed cellular polyurethane foam pad 10 reaches the rest position 60 at the side of the magnetic tape head 65.

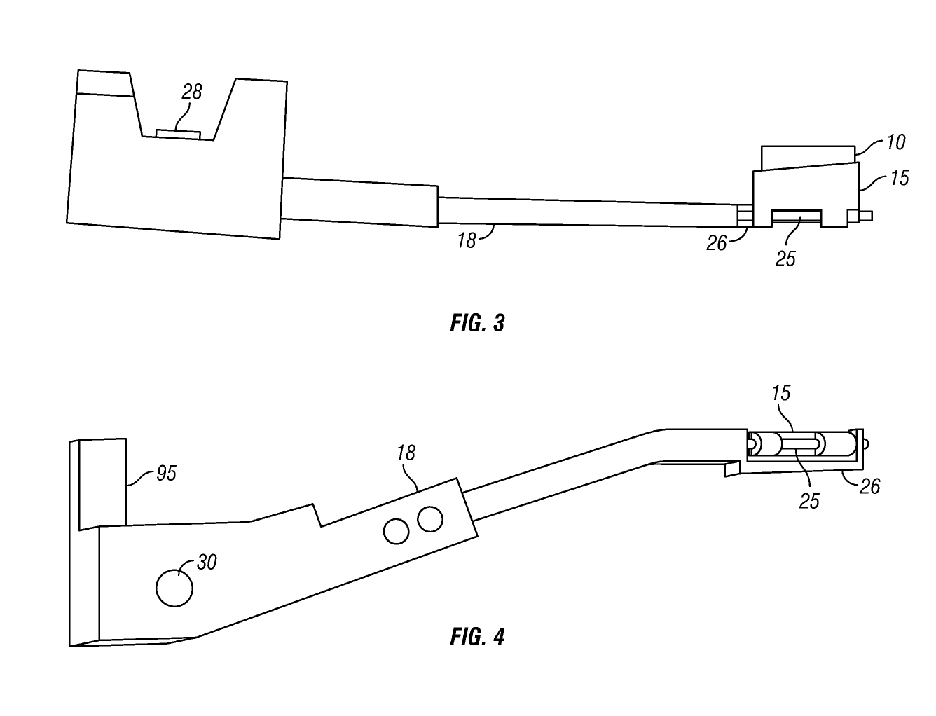

FIGS. 3 and 4 illustrate an embodiment of a support member comprising a support arm 18 and holder 15 for the closed cellular polyurethane foam pad 10. In the example, the holder 15 is fixed in position by a pin 25 held by a frame 26 of the support arm 18. In one example, the pin 25 is threaded, and in another example, the pin is an interference fit with respect to both the holder 15 and the frame 26. In another example, the support arm 18 and holder 15 are a common casting or molded part. In the example of FIGS. 3 and 4, the support member 18, is configured to pivot on bearing 28 about pivot 30, so as to move as illustrated by the method depicted in FIGS. 1 and 2.

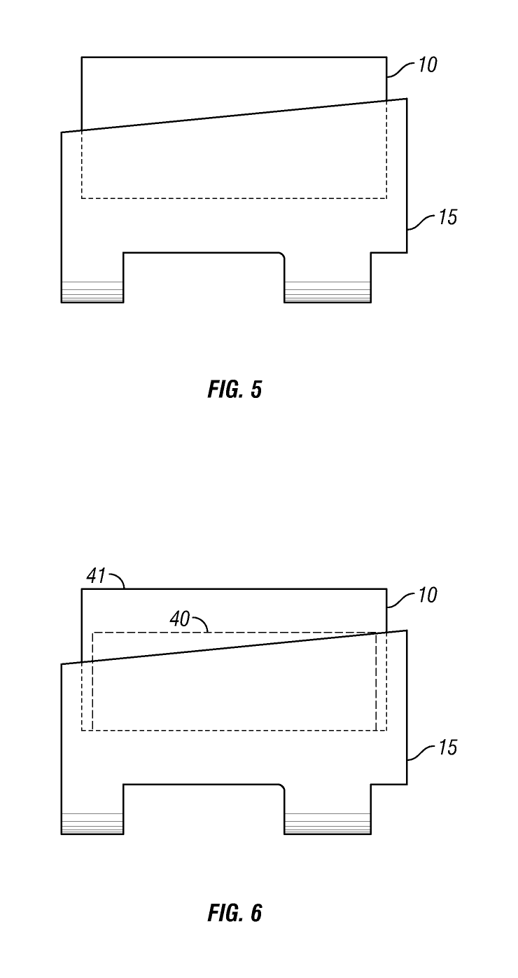

Embodiments of the closed cellular polyurethane foam pad 10 are illustrated in FIGS. 5 and 6.

The embodiment of pad 10 of both FIG. 5 and FIG. 6 comprises a closed cellular polyurethane foam pad comprising a Shore hardness of substantially 55-60.

The embodiment of pad 10 of FIG. 6 additionally comprises an interior reinforcing layer 40. A closed cellular polyurethane foam material 41 coats or overlays the interior reinforcing layer 40 on at least all surfaces that are arranged to contact the read/write surface(s) of the magnetic tape head. The interior reinforcing layer 40 comprises 95 to 5 percent by volume of the combined interior reinforcing layer and closed cellular polyurethane foam 41 of the pad 10. The reinforcing layer comprises a polymer material, or a more dense foam material than the foam of the closed cellular polyurethane foam material 41. Herein, when referring to the characteristics of the foam pad 10, the characteristics refer to the foam material 41. An advantage of the interior reinforcing layer is to increase the durability of the pad 10.

Referring to FIGS. 5 and 6, in one embodiment, the closed cellular polyurethane foam pad 10 comprises a density of 1.0 to 0.15 g/cm³, and preferably from 0.6 to 0.2 g/cm³, and in a further embodiment, the closed cellular polyurethane foam pad comprises a density of substantially 0.5 to 0.3 g/cm³.

In another embodiment, the closed cellular polyurethane foam pad 10 additionally comprises an abrasive particle filler having a concentration of 10 to 0.01 percentage by weight, and preferably from 5 to 0.1 percentage by weight, and in a further embodiment, the closed cellular polyurethane foam pad abrasive particle filler comprises a concentration of substantially 3 to 0.5 percentage by weight. In one embodiment, the abrasive particle filler is one of Alumina and Titanium oxide. An advantage of the abrasive particle filler is to increase the level of abrasion by the pad 10.

In another embodiment, the closed cellular polyurethane foam pad 10 additionally is impregnated with a carbon based conductive filler having a concentration of 15 to 0.01 percentage by weight, and preferably 10 to 0.1 percentage by weight, and in a further embodiment, the closed cellular polyurethane foam pad is impregnated with the carbon based conductive filler to a concentration of substantially 5 to 0.5 percentage by weight. Examples of carbon based conductive fillers comprise carbon black, graphite, and carbon nanotubes (single and multi-walled). An advantage of the carbon based conductive filler is to provide ESD (electrical static discharge) protection to the magnetic tape head.

The closed cellular polyurethane foam pad 10 is preferably employed without a solvent, and may therefore be called “solventless”.

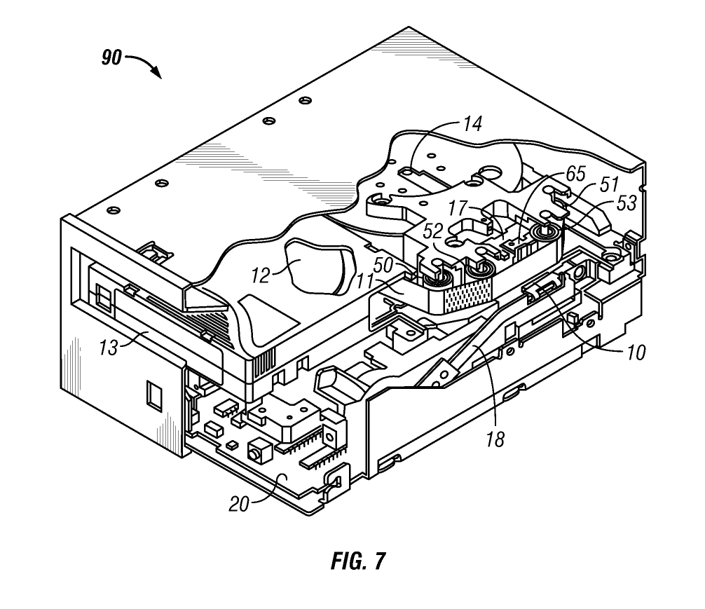

FIG. 7 illustrates a magnetic tape data storage drive 90 which writes data 18 to and reads data from longitudinal magnetic tape data storage media 11, and in which the magnetic tape head cleaner is implemented. As is understood by those of skill in the art, magnetic tape data storage drives, also called magnetic tape drives or tape drives, may take any of various forms. The illustrated magnetic tape drive 90 moves the magnetic tape 11 along a tape path in the longitudinal direction of the tape from a supply reel 12 in a magnetic tape data storage cartridge 13 to a take up reel 14. An example of a magnetic tape drive is the IBM® LTO (Linear Tape Open) magnetic tape drive. Another example of a magnetic tape drive is the IBM® TotalStorage Enterprise magnetic tape drive. Both the above examples of magnetic tape drives employ single reel tape cartridges 13. An alternative magnetic tape drive and magnetic tape cartridge is a dual reel cartridge and drive in which both reels 12 and 14 are contained in the cartridge.

The magnetic tape media 11 is moved in the longitudinal direction of the tape and across the magnetic tape head 65. The tape head may be supported and laterally moved by a compound actuator 17 of a track following servo system. The magnetic tape media is supported by roller tape guides 50, 51, 52, 53 while the magnetic tape media is moved longitudinally.

A typical magnetic tape data storage drive operates in both the forward and reverse directions to read and write data. Thus, the magnetic tape head 65 may comprise one set of read and write elements for operating in the forward direction and another set for operating in the reverse direction, or alternatively, may have two sets of the read elements on either side of the write elements to allow the same write elements to write in both directions while the two sets of read elements allow a read-after-write in both directions.

The magnetic tape data storage drive 90 comprises one or more controls 20 for operating the magnetic tape data storage drive in accordance with commands received from an external system. The external system may comprise a network, a host system, a data storage library or automation system, a data storage subsystem, etc., as is known to those of skill in the art. A control typically comprises logic and/or one or more microprocessors with a memory for storing information and program information for operating the microprocessor(s) and drive. The program information may be supplied to the memory via an interface, by an input to the control 20 such as a floppy or optical disk, or by reading from a magnetic tape cartridge, or by any other suitable means. The magnetic tape data storage drive 10 may comprise a standalone unit or comprise a part of a tape library or other subsystem, which may comprise the external system. The control 20 also provides the data flow and formatter for data to be read from and written to the magnetic tape media, as is known to those of skill in the art.

The magnetic tape drive 90 is configured to receive a magnetic tape cartridge 13 oriented in a single direction, and to engage and move the cartridge into a specified position in the cartridge receiver. A tape threading mechanism moves the free end of the magnetic tape 11 from the magnetic tape cartridge 13 to a take up reel 14, for example, positioning the free end leader block at the central axis of the take up reel. The magnetic tape is thus positioned along the tape path. Before the tape is threaded into the magnetic tape drive, the control 20 operates the support member 18 to move the closed cellular polyurethane foam pad 10 across and in contact with the read/write surface(s) of the magnetic tape head 65. Referring additionally to FIG. 2, the closed cellular polyurethane foam pad 10 of FIG. 7 is illustrated in position 62 of FIG. 2, with the tape cartridge 13 of FIG. 7 loaded and the magnetic tape 11 threaded and positioned along the tape path.

Referring additionally to FIG. 4, as one example, the mechanism operated by the control 20 to engage and move the cartridge 13 into position also engages a lever 95 of the support arm 18 to pivot the support member 18, 15 about the pivot 30 to thereby move closed cellular polyurethane foam pad 10 across and in contact with the read/write surface(s) of the magnetic tape head 65 as illustrated in and as described with respect to FIG. 2. Conversely, the mechanism operated by control 20 to unload the cartridge 13 also engages lever 95 of the support arm 18 to pivot the support member 18, 15 to move the closed cellular polyurethane foam pad 10 back across and in contact with the read/write surface(s) of the magnetic tape head 65.

Alternative arrangements of mechanisms to move the support member 18, to thereby move closed cellular polyurethane foam pad 10 across and in contact with the read/write surface(s) of the magnetic tape head 65 may be envisioned by those of skill in the art.

The implementations of control 20 may involve software, firmware, micro-code, hardware and/or any combination thereof. The implementation may take the form of code or logic implemented in a medium, where the medium may comprise hardware logic (e.g. an integrated circuit chip, Programmable Gate Array [PGA], Application Specific Integrated Circuit [ASIC], or other circuit, logic or device), or a computer readable storage medium, such as a magnetic storage medium (e.g. an electronic, magnetic, optical, electromagnetic, infrared, or semiconductor system, semiconductor or solid state memory, magnetic tape, a removable computer diskette, and random access memory [RAM], a read-only memory [ROM], a rigid magnetic disk and an optical disk, compact disk-read only memory [CD-ROM], compact disk-read/write [CD-R/W] and DVD).

Those of skill in the art will understand that changes may be made with respect to the methods discussed above, including changes to the ordering or direction of motion of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A magnetic tape head cleaner for a magnetic tape head having at least one read/write surface, wherein said magnetic tape head is configured to read and write data with respect to a movable magnetic tape as said tape is moved in a longitudinal direction of said tape and across said at least one read/write surface of said head, said magnetic tape head cleaner comprising:
a closed cellular polyurethane foam pad; and
a support member configured to support said pad for movement of said pad across and in contact with said at least one read/write surface of said magnetic tape head.

2. The magnetic tape head cleaner of claim 1, wherein said closed cellular polyurethane foam pad comprises a Shore hardness of substantially 55-60.

3. The magnetic tape head cleaner of claim 2, wherein said closed cellular polyurethane foam pad comprises a density of 1.0 to 0.15 g/cm³.

4. The magnetic tape head cleaner of claim 3, wherein said closed cellular polyurethane foam pad comprises a density of substantially 0.5 to 0.3 g/cm³.

5. The magnetic tape head cleaner of claim 2, wherein said closed cellular polyurethane foam pad additionally comprises an abrasive particle filler having a concentration of 10 to 0.01 percentage by weight.

6. The magnetic tape head cleaner of claim 5, wherein said closed cellular polyurethane foam pad abrasive particle filler comprises a concentration of substantially 3 to 0.5 percentage by weight.

7. The magnetic tape head cleaner of claim 5, wherein said abrasive particle filler is one of Alumina and Titanium oxide.

8. The magnetic tape head cleaner of claim 2, wherein said closed cellular polyurethane foam pad additionally is impregnated with a carbon based conductive filler having a concentration of 15 to 0.01 percentage by weight.

9. The magnetic tape head cleaner of claim 8, wherein said closed cellular polyurethane foam pad is impregnated with said carbon based conductive filler to a concentration of substantially 5 to 0.5 percentage by weight.

10. A magnetic tape head cleaner for a magnetic tape head having at least one read/write surface, wherein said magnetic tape head is configured to read and write data with respect to a movable magnetic tape as said tape is moved in a longitudinal direction of said tape and across said at least one read/write surface of said head, said magnetic tape head cleaner supported for movement across and in contact with said at least one read/write surface of said magnetic tape head, said magnetic tape head cleaner comprising:
an interior reinforcing layer; and
a closed cellular polyurethane foam pad overlaying said interior reinforcing layer on at least all surfaces that are arranged to contact said at least one read/write surface of said magnetic tape head.

11. The magnetic tape head cleaner of claim 10, wherein said interior reinforcing layer comprises 95 to 5 percent by volume of combined said interior reinforcing layer and said closed cellular polyurethane foam pad.

12. The magnetic tape head cleaner of claim 11, wherein said closed cellular polyurethane foam pad comprises a Shore hardness of substantially 55-60.

13. The magnetic tape head cleaner of claim 12, wherein said closed cellular polyurethane foam pad comprises a density of 1.0 to 0.15 g/cm³.

14. The magnetic tape head cleaner of claim 13, wherein said closed cellular polyurethane foam pad comprises a density of substantially 0.5 to 0.3 g/cm³.

15. The magnetic tape head cleaner of claim 12, wherein said closed cellular polyurethane foam pad additionally comprises an abrasive particle filler having a concentration of 10 to 0.01 percentage by weight.

16. The magnetic tape head cleaner of claim 15, wherein said closed cellular polyurethane foam pad abrasive particle filler comprises a concentration of substantially 3 to 0.5 percentage by weight.

17. The magnetic tape head cleaner of claim 15, wherein said abrasive particle filler is one of Alumina and Titanium oxide.

18. The magnetic tape head cleaner of claim 12, wherein said closed cellular polyurethane foam pad additionally is impregnated with a carbon based conductive filler having a concentration of 15 to 0.01 percentage by weight.

19. The magnetic tape head cleaner of claim 18, wherein said closed cellular polyurethane foam pad is impregnated with said carbon based conductive filler to a concentration of substantially 5 to 0.5 percentage by weight.

20. A method for cleaning a magnetic tape head having at least one read/write surface, wherein said magnetic tape head is configured to read and write data with respect to a movable magnetic tape as said tape is moved in a longitudinal direction of said tape and across said at least one read/write surface of said head, said method comprising:
moving a closed cellular polyurethane foam pad comprising a Shore hardness of substantially 55-60 and comprising a density of 1.0 to 0.15 g/cm³ across and in contact with said at least one read/write surface of said magnetic tape head.
